(19) United States
(12) Patent Application Publication
(10) Pub. No.: US 2010/0151421 A1
(43) Pub. Date: Jun. 17, 2010

(54) DENTAL IMPLANT

(75) Inventors: James A. Devengencie, Grafton, OH (US); Mark A. Fiorina, Elm Grove, WI (US); James Bahcall, Buffalo Grove, IL (US); Mark Andrew Fiorina, Elm Grove, WI (US)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: Plastic Dental Corporation

(21) Appl. No.: 12/616,177

(22) Filed: Nov. 11, 2009

Related U.S. Application Data
(60) Provisional application No. 61/122,023, filed on Dec. 12, 2008.

(51) Int. Cl. A61C 8/00

(52) U.S. Cl. 433/174; 433/173; 433/215

(57) ABSTRACT

A dental implant includes a first member (100) having a proximal end (102) and a distal end (104) and extends along a longitudinal axis (62). The proximal end (102) has an axial end surface (103). The first member (102) is formed from a first material. A second member (70) is integrally formed with the first member (100) and is adapted to receive a dental prosthesis (150). The second member (70) engages the entire proximal end surface (103) of the first member (100). The second member (70) intersects the axis (62) of the first member (100) at the proximal end surface (103) to prevent access to the proximal end surface (103) of the first member (100) through the second member (70). The second member (70) is formed from a polymer that is different from the first material of the first member (100).

### RELATED APPLICATIONS

This application claims the benefit of U.S. Provisional Patent Application No. 61/122,023, filed Dec. 12, 2008, the entirety of which is incorporated herein by reference.

### TECHNICAL FIELD

The present invention relates to dental implants and, in particular, relates to an abutment for receiving a prosthetic tooth.

### BACKGROUND OF THE INVENTION

Teeth sit within sockets in the alveolar bone of the upper and lower jaw. Each socket is lined with a connective tissue known as the periodontal membrane or ligament. This periodontal membrane connects to a calcified connective tissue, known as cementum, that covers the roots of the teeth. In a healthy mouth, these connective tissues between the teeth and the bone anchor the teeth in the sockets and absorb shock when the teeth are subject to occlusive forces during mastication.

In an unhealthy mouth, periodontal disease may result in severe damage to the connective tissues that hold the teeth in the sockets. Periodontal disease is a progressive process that results in the destruction of the periodontal membrane, the receding of the gums, and, ultimately, the destruction of the alveolar bone (jawbone). In advanced stages, the disease can lead to the loosening of teeth, and the need to extract and replace the teeth.

A variety of tooth replacements commonly referred to as dental implants have been developed over time. Most dental implants used in dentistry today have multiple, complex, and expensive components.

Furthermore, the accompanying technique for restoration with a crown or bridge can involve several complicated steps. These considerations substantially limit the dentists in the United States who offer dental implants to their patients.

Moreover, the color of most dental implant abutments is silver, gray or gold. This is an aesthetic problem in the visible areas of the mouth in that the dark color is difficult to hide. The procedures commonly used to cover these darkened areas are complicated and the implant results are often compromised. Zirconium and ceramic abutments have been developed to address this problem, but most are inherently weak due to their construction. In particular, the abutments are typically hollow in order to allow a screw to be placed through them to attach the abutment to the dental implant body within the jaw. The ceramic abutments are also expensive relative to traditional metal abutments.

Additionally, many manufacturers do not recommend further processing, e.g., buffering, shaping, of the ceramic abutment once placed in the mouth because the crystalline structure is compromised and weakened. Even if the manufacturer allows for oral preparation, the procedure is difficult due to the hard, brittle construction of ceramic. Based on the foregoing, there is a need in the art for a simple, tooth colored, and workable abutment for dental implants.

### SUMMARY OF THE INVENTION

The present invention relates to a dental implant that includes a first member that has a proximal end and a distal end and extends along a longitudinal axis. The proximal end has an axial end surface. The first member is formed from a first material. A second member is integrally formed with the first member and is adapted to receive a dental prosthesis. The second member engages the entire proximal end surface of the first member. The second member intersects the axis of the first member at the proximal end surface to prevent access to the proximal end surface of the first member through the second member. The second member is formed from a polymer that is different from the first material of the first member.

According to another aspect of the present invention a method for securing a dental implant to a jaw includes providing a first member that includes a proximal end and a distal end, and a polymer second member integrally formed with the first member and adapted to receive a dental prosthesis. The second member is engaged to rotate the first member and the second member to secure the implant with the jaw.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a side view of a dental implant in accordance with the present invention;

FIG. 2 is an exploded section view taken along line 2-2 of FIG. 1; FIG. 3A is an enlarged view of a portion of the dental implant of FIG. 1;

FIG. 3B is an enlarged view of a portion of the dental implant of FIG. 1;

FIG. 4 is a schematic illustration of the dental implant of FIG. 2 being secured to a jaw;

FIG. 5 is a schematic illustration of a dental prosthesis being secured to the dental implant;

FIG. 6 is a side view of an alternative embodiment of a dental implant of the present invention;

FIG. 7 is a side view of the dental implant of FIG. 6 with a modified implant body;

FIG. 8 is a side view of another embodiment of a dental implant of the present invention; and

FIG. 9 is a side view of the dental implant of FIG. 8 with a modified implant body.

### DETAILED DESCRIPTION

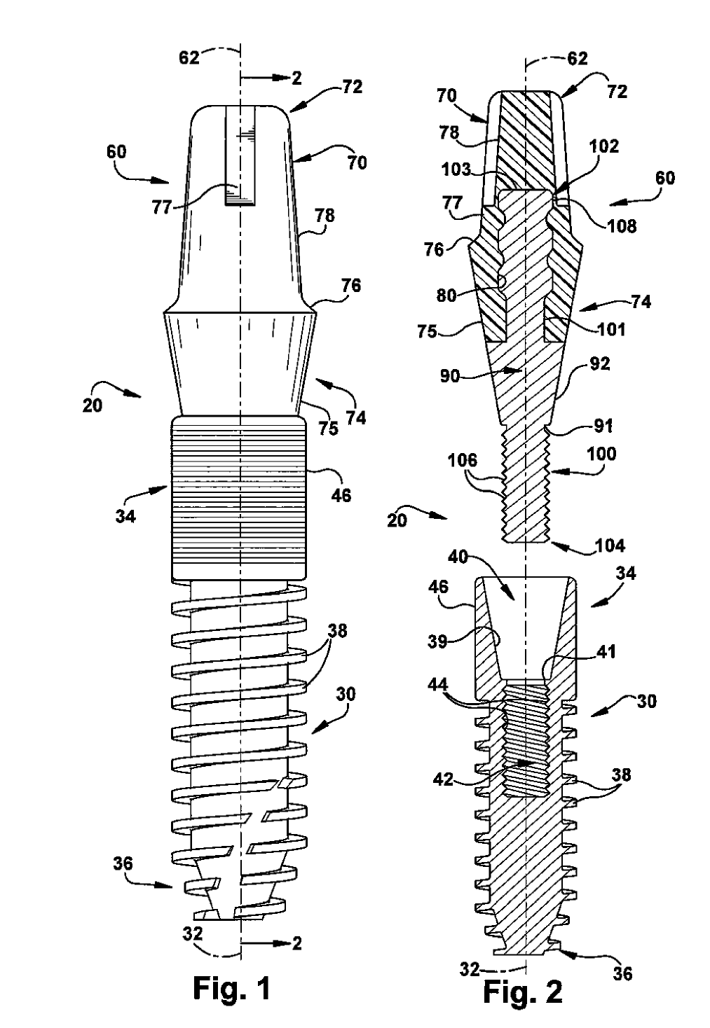

The present invention relates to dental implants and, in particular, relates to an abutment for receiving a prosthetic tooth. FIG. 1 illustrates a dental implant 20 in accordance with the present invention. The dental implant 20 includes an implant body 30 for implantation into a jaw 130 of a patient and an abutment 60 for receiving a dental prosthesis. Although the abutment 60 is illustrated and described as being used with a particular implant body 30 for illustrative purposes, the abutment of the present invention could likewise be used with any implant body.

The implant body 30 extends along a longitudinal axis 32 and has a generally cylindrical construction. The implant body 30 includes an attachment axial end portion 34 and a fastening axial end portion 36. The abutment 60 is connected to the attachment portion 34. The fastening portion 36 extends axially from the attachment portion 34 and engages the jaw 130 to connect the implant 20 to the jaw.

The attachment portion 34 has a generally tubular shape and includes a first passage 40 defined by an inner surface 39. The first passage 40 extends axially toward the fastening portion 36. The first passage 40 is generally frustoconical and narrows in a direction perpendicular to the longitudinal axis 32 as the passage extends axially toward the fastening portion. The first passage 40 terminates at a shoulder surface 41 that is substantially perpendicular to the axis 32 of the implant body 30.

The fastening portion 36 extends axially from the attachment portion 34 and has a generally tubular shape. The fastening portion 36 includes one or more external threads 38 that may have any construction. Alternatively, the fastening portion 36 may be provided with one or more fins extending parallel to one another (not shown). Moreover, the fastening portion 38 may have a smooth outer surface free of engagement structure of any kind (not shown).

The fastening portion 36 further includes a second passage 42 that extends axially from the shoulder surface 41 and through at least a portion of the fastening portion. One or more threads 44 are formed along the interior of the second passage 42. The threads 44 may have any construction such as helical, square or the like. Alternatively, the interior of the second passage 42 may be smooth (not shown).

The implant body 30 may be formed from any high strength biocompatible material suitable for placement into a jaw. The implant body 30 may, for example, be formed of one or more metals such as titanium, steel, zirconium or alloys thereof. Alternatively, the implant body 30 may be formed from a suitable non-metallic material.

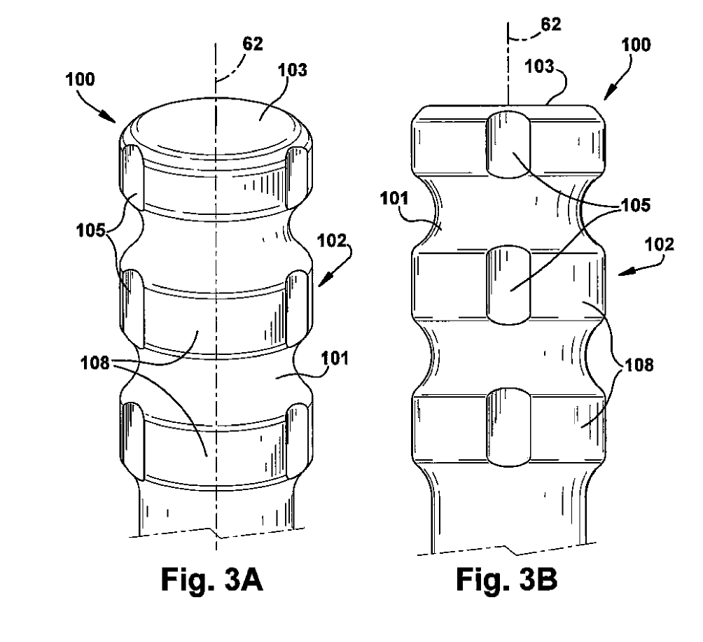

The abutment 60 includes a receiving member 70 and a fastening member 100. The receiving member 70 includes a receiving portion 72 for connecting the abutment 60 to the dental prosthesis and an attachment portion 74 for connecting the abutment to the dental implant 30. The receiving portion 72 has a solid frustoconical construction although alternative shapes may be used, such as cylindrical. The receiving portion 72 includes an outer surface 78 which may be smooth or alternatively may be knurled or otherwise textured to facilitate attachment of the receiving portion to the dental prosthesis. The receiving portion 72 further includes axially extending recessed portions 77 for receiving a tool 96 (see FIG. 3) for connecting the abutment 60 to the implant body 30.

As shown in FIGS. 1-2, the attachment portion 74 extends axially from the receiving portion 72 and has a tapered construction that narrows in a direction extending away from the receiving portion. Alternatively, the attachment portion 74 may exhibit other shapes, such as arcuate, cylindrical, cubic or the like. The attachment portion 74 includes an outer surface 75 and a tapered annular portion 76. The tapered annular portion 76 encircles the attachment portion 74 and interconnects the attachment portion and the receiving portion 72. The annular portion 76 may have a contour that is linear, arcuate or scalloped. In any case, the annular portion 76 is tapered in a direction opposite the direction in which the attachment portion 74 is tapered.

The receiving member 70 may be formed from any biocompatible polymer suitable for placement into the jaw. The receiving member 70 may, for example, be formed from at least one of polyether ether ketone (PEEK), polymethylmethacrylate (PMMA), polyaryl ether ketone (PAEK), polyether ketone (PEK), polyether ketone ether ketone ketone (PEKEKK), polyether ketone ketone (PEKK), polyehterimide (PEI), polysulfone (PSu), poluphenylsulfone (PPSu), thermoplastic polymers, thermoset polymers, and combinations thereof.

The fastening member 100 of the abutment 60 has a generally elongated shape that includes an axially extending wall 101 having a linear and/or arcuate contour. The fastening member 100 has a proximal end 102 and a distal end 104 and extends along a longitudinal axis 62. The proximal end 102 terminates at an upper axial end surface 103. A plurality of external threads 106 extend around the fastening member 100 from the distal end 104 towards the proximal end 102. The threads 106 on the fastening member 100 may be helical, square or the like so long as the threads are configured to mate with the internal threads 44 on the implant body 30. The fastening member 100 may be formed from any high strength biocompatible material suitable for placement into a jaw. The fastening member 100 may, for example, be formed of one or more metals such as titanium, steel, zirconium or alloys thereof. Alternatively, the fastening member 100 may be formed from a suitable non-metallic material.

Although the fastening member 100 of the abutment 60 and the implant body 30 are illustrated as having a threaded connection, it will be understood that the fastening member and the implant body can have any releasable connection. For example, the fastening member 100 may have a press fit connection with the implant body 30. Alternatively, the threaded connection may be reversed such that the fastening member 100 has internal threads and the implant body 30 has external threads. Moreover, the fastening member 100 and the implant body 30 may be connected by releasable fasteners such as hooks, clamps, pins or the like (not shown).

The receiving member 70 is integrally formed with the fastening member 100 such that the receiving and fastening members form a single piece. The receiving member 70 may, for example, be molded with the fastening member 100 using injection molding, compression molding, thermoforming or the like. During molding, an inner surface 80 of the receiving member 70 bonds with the axial walls 105 of the fastening member 100 to rigidly couple the receiving member to the fastening member. In particular, the receiving member 70 is molded over the fastening member 100 such that the receiving member encapsulates the proximal end 102 of the fastening member. In other words, the receiving member 70 when molded over the fastening member 100 fully encloses the proximal end 102 of the fastening member. The receiving member 70 therefore engages and overlies the entire end surface 103 of the proximal end 102 of the fastening member 100 and intersects the central axis 62 of the fastening member at the end surface. The end surface 103 of the fastening member 100 therefore becomes inaccessible through the receiving member 70. The receiving member 70 is free of openings due to the integral connection between the receiving member and the fastening member 100.

The abutment 60 may include at least one reinforcing member 108 for reinforcing the integral connection between the receiving member 70 and the fastening member 100. As shown in FIGS. 3A-B, the reinforcing members 108 may constitute one or more annular elements that are integrally formed with or otherwise secured to the proximal end 102 of the fastening member 100. The reinforcing members 108 may, for example, be continuous annular flanges that extend radially outward from the fastening member 100. Alternatively or additionally, the reinforcing members 108 may include a series of discrete, axially extending flanges or a series of threads (not shown). The reinforcing members 108 increase the surface area of the fastening member 100 and thereby increase the surface area over which the inner surface 80 of the receiving member 70 is connected to the proximal end 102 of the fastening member. This increased surface area adds rigidity, stability, and reliability to the molded connection between the receiving member 70 and the fastening member 100. The reinforcing members 108 may be made from any suitable biocompatible material such as metals or plastics.

Each of the reinforcing members 108 includes one or more axially extending recesses 105. The recesses 105 increase the surface area of the fastening member 100 and thereby increase the surface area over which the inner surface 80 of the receiving member 70 is connected to the proximal end 102 of the fastening member. Each recess 105 may have an arcuate shape that extends inwardly towards the longitudinal axis 62, although the recesses may have alternative shapes such as triangular, square, etc. The recesses 105 may be radially spaced around the periphery of each reinforcing member 108 in a uniform or non-uniform manner. For example, as shown in FIGS. 3A-3B, four recesses 105 may be spaced 90° from one another about each reinforcing member 108. The recesses 105 may be positioned on each reinforcing member 108 such that the recesses are axially aligned with one another along a direction that is substantially parallel to the longitudinal axis 62.

Although FIGS. 3A-3B illustrate a particular configuration for the recesses 105, the recesses can exhibit alternative configurations within the spirit of the invention. For example, each reinforcing member 108 may include more or fewer recesses 105, including zero recesses. Furthermore, the recesses 105 may each extend towards the longitudinal axis 62 the same amount or different amounts, i.e., the recesses may have varying depths. Additionally or alternatively, some or all of the recesses 105 may be misaligned from other recesses in the longitudinal direction.

The fastening member 100 includes a middle portion 90 that interconnects the proximal end 102 and the distal end 104 of the fastening member. The middle portion 90 includes an axial end surface 91 and an outer surface 92 that act as stops to limit the depth of insertion of the fastening member 100 into the implant body 30. The middle portion 90 may have a frustoconical shape, although other shapes such as pyramid, cubic, cylindrical, etc. are contemplated. The outer surface 92 of the middle portion 90 may have a shape that is aligned with the outer surface 75 of the attachment portion 74. In other words, the outer surface 92 of the middle portion 90 may extend the frustoconical shape of the outer surface 75 of the attachment portion 74. Collectively, the outer surface 92 of the middle portion 90 and the outer surface 75 of the attachment portion 74 mirror the shape of the inner surface 39 of the implant body 30.

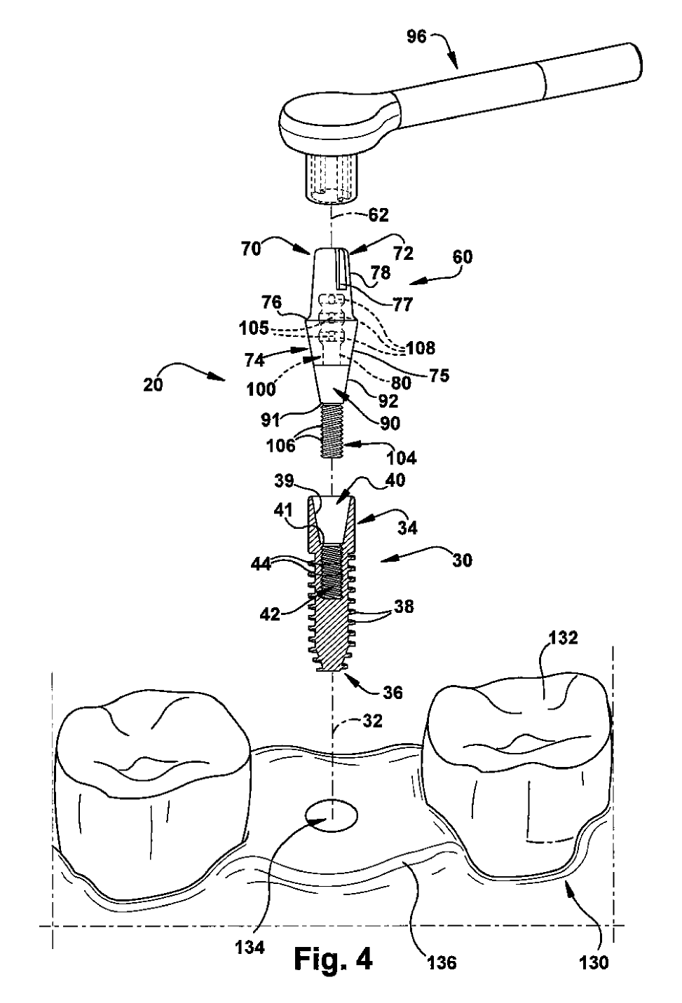

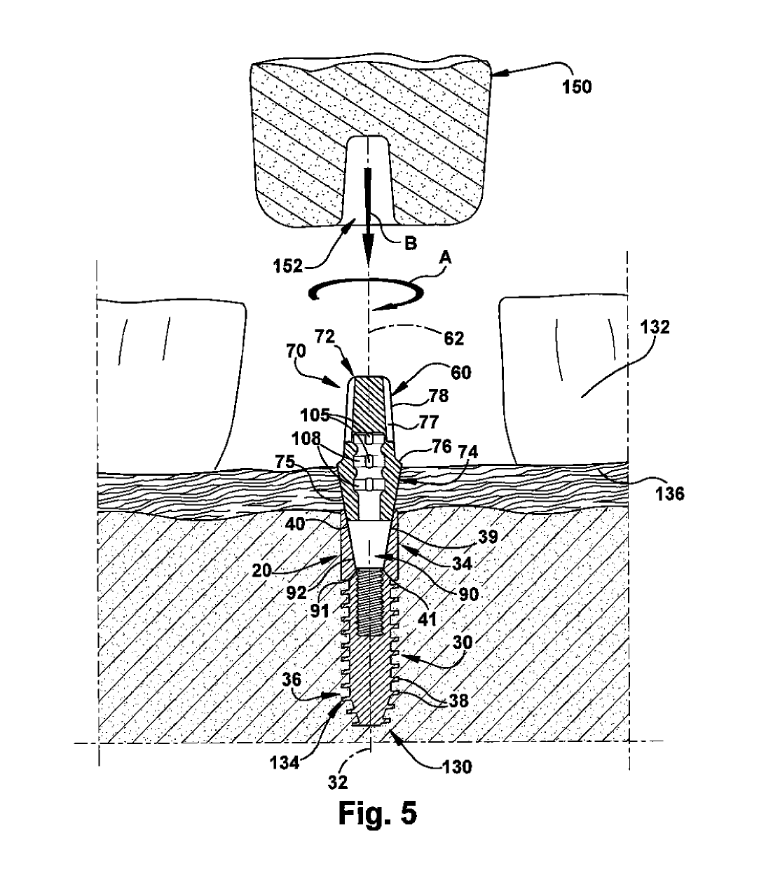

As shown in FIGS. 4-5, the dental implant 20 is installed at a predetermined location along a jaw 130 of the patient where it is desirable to implant a dental prosthesis. The target site for the dental implant 20 may, for example, be located along the gum line 136 adjacent one or more healthy teeth 132. A hole 134 is drilled or otherwise formed through the gum line 136 and into the jaw 130 using conventional dentistry tools. The hole 134 is sized and shaped to receive the implant body 30.

The fastening portion 36 of the implant body 30 is positioned within the hole 134 in the jaw 130 to secure the implant body to the jaw. If the fastening portion 36 includes threads 38, the threads will engage the surface of the jaw 130 defining the hole 134 to secure the implant body 30 and, thus, the dental implant 20 to the jaw. The threads 38 or fins are provided to increase the surface area, stability, retention, and stimulation of the jaw 130 bone to maintain homeostasis. Such increased surface area may be desirable when, for example, the implantation site in the jaw 130 does not require moderate or severely angled abutments 60.

On the other hand, if the fastening portion 36 does not include threads 38, then the fastening portion forms a press-fit engagement with the surface of the jaw 130 defining the hole 134 to secure the dental implant 20 to the jaw. A smooth fastening portion 36 may be desirable when, for example, the implantation site in the jaw 130 requires moderate or severely angled abutments 60 in relation to the implant body 30 due to natural tooth and jaw positions. Regardless of the configuration of the implant body 30, the fastening portion 36 may include additional structure and/or be chemically or physically treated, coated or otherwise altered to promote bone growth and permanent fixation of the implant body 30 to the jaw 130.

The abutment 60 is then secured to the implant body by aligning the axis 62 of the fastening member 100 of the abutment with the axis 32 of the implant body and guiding the fastening member through the first passage 40 in the implant body and into the second passage 42. Eventually, the threads 106 on the fastening member 100 engage the threads 44 in the second passage 42 of the implant body 30. Due to the solid construction of the receiving member 70 of the abutment 60, the receiving member may be articulated by an appropriate tool 96 in order to install the abutment into the implant body 30. More specifically, the abutment 60 is articulated by inserting keys or splines on the tool into the recessed portions 77 on the outer surface 78 of the receiving member 70. The knurled or textured outer surface 78 may facilitate grasping by the tool 96.

By subsequently rotating the abutment 60 with the tool 96 in the manner indicated generally by arrow A in FIG. 5, the abutment and the implant body 30 threadably engage, causing the abutment to advance into the implant body 30 and jaw 130 in the axial direction indicated generally by arrow B. As the abutment 60 moves in the direction B, the fastening member 100 of the abutment advances further into the second passage 42 of the implant body 30 and the tapered middle portion 90 advances into the first passage 40.

As shown in FIG. 5, the abutment 60 continues to advance into the implant body 30 until the end surface 91 of the middle portion 90 abuts the shoulder surface 41 of the attachment portion 34 of the implant body, thereby preventing further axial movement of the abutment 60 into the implant body. Likewise, the frustoconical outer surface 92 of the middle portion 90 abuts the inner surface 39 of the frustoconical first passage 40 in the attachment portion 34 to prevent further axial movement of the abutment 60 into the implant body 30. The middle portion 90 of the abutment 60 and the first passage 40 of the implant body 30 are configured such that, when the middle portion bottoms out in the first passage, the tapered portion 76 of the receiving member 70 is positioned at or adjacent the gum line 136 of the jaw 130 (FIG. 5).

As noted, the connection between the fastening member 100 of the abutment 60 and the implant body 30 may be different from the connection illustrated. For example, the threaded second passage 42 of the implant body 30 and the threaded distal end 106 of the fastening member 100 may be omitted. In such a case, the outer surface 92 of the middle portion 90 may form a press fit connection with the inner surface 39 of the implant body 30. Alternatively, if the implant body 30 has only a threaded passage or does not have any passages, the end surface 91 of the middle portion 90 may engage the proximal end 34 of the implant body when the abutment 60 is secured to the implant body.

In any case, the connection between the abutment 60 and the implant body 30 is configured to provide a durable, stable connection that is quick and easy to form. When the threads 106 on the fastening member 100 and the threads 44 along the second passage 42 of the implant body 30 are both formed of metal, the threaded connection forms a cold weld. This cold weld, in combination with the engagement between the metal middle portion 90 and the tapered first passage 40 of the implant body 30 creates an effective seal between the abutment and the implant body. The seal resists oral bacterial ingress into the implant body and otherwise prevents water, saliva, debris or other oral particulates from entering the dental implant 20, thereby increasing the reliability, functionality, and stability of the dental implant.

Furthermore, due to the two piece connection between the fastening member 100 of the abutment 60 and the implant body 30, the present invention provides a simple installation for the dental implant 20 utilizing minimal parts and effort. Conventional abutments are secured to implant bodies using a separate threaded fastener. In order to accommodate the fastener, the abutment must be hollow, thereby weakening the abutment. Once the fastener secures the implant together, the abutment is typically filled with dental restorative material to fill and seal the hollow access chamber.

The abutment 60 of the present invention is advantageous over these conventional hollow abutments for several reasons. First, the one-piece construction of the abutment 60 with appropriate fastening structure allows the abutment to be secured to the implant body 30 without the need for additional hardware, thereby reducing the number of parts and complexity of installation of the dental implant.

Second, the one-piece construction of the abutment 60 is advantageous because fewer pathways exist for harmful oral pathogens to infiltrate the dental implant 20. Dental implants are typically placed so that the trailing edge of the implant body approximates the bone level along the gum line. These conventional multi-component abutment-implant body interfaces are therefore approximately at the bone level. This interface is a source of accumulation of bacteria and other oral pathogens. These pathogens can cause destruction of the adjacent biologic tissues that support the implant, ultimately resulting in bone loss around the implant body. Since the abutment 60 of the present invention is fabricated as one fused piece and the interface between the abutment and the implant body 30 is a sealed cold weld, the aforementioned deficient interface found in typical dental implants is absent in the present invention.

Moreover, the one-piece construction of the abutment 60, coupled with the solid construction of the receiving part 74, provides a rigid connection between the abutment and the implant body that is reversible. In particular, the structurally sound polymer receiving part 74 can be engaged by the tool 96 to engage and disengage the abutment 60 from the implant body 30 to, for example, replace the abutment over time. For these reasons, the abutment 60 of the present invention can be installed using a simple tool 96 while providing a stable, rigid connection between the abutment and the implant body 30 without compromising the integrity of the abutment.

The abutment 60 of the present invention is also advantageous over existing abutments because the abutment can be quickly and easily remodeled or shaped in-vivo. Since the receiving member 70 of the abutment 60 is formed from a polymer, the receiving member and, in particular, the tapered portions 76 and 78 may be altered while the dental implant 20 is connected to in the jaw 130. This may be desirable to, for example, shape the tapered portions 76 and 78 to follow the contour of the gum line 136 to give the dental prosthesis 150 a more realistic and appealing appearance. The in-viva shaping of the abutment 60 may be performed using tools that polish, grind, cut, sand, carve, shave, etc. in order to shape, contour or otherwise change the appearance of the abutment to more accurately resemble the natural tooth crowns in shape and consistency. Accordingly, material may be removed from the receiving member 70 while the receiving member is connected with the jaw 130. Manufacturers do not recommend shaping ceramic abutments in-vivo because reshaping the brittle ceramic may compromise the crystalline structure, thereby undesirably weakening the abutment.

Once the dental implant 20 is secured within the jaw 130 a dental prosthesis, such as a cemented crown or prosthetic tooth 150 may be secured to the dental implant. The tooth 150 includes a bore 152 configured to mate with the receiving portion 72 of the receiving member 70 of the abutment 60. The receiving portion 72 and the bore 152 may have a press-fit or interference fit connection. Alternatively, the receiving portion 72 and the bore 152 may have a threaded connection (not shown). In any case, the dental implant 20 of the present invention is configured to provide a rigid, stable interface between the jaw 130 and the dental prosthesis 150. More specifically, the reinforcing members 108 and the middle portion 90 of the abutment 60 provide rigidity to a region of the attachment portion 74 that may experience relatively high tensile and torsional stress during fastening of the abutment to the implant body 30 or during fastening of the prosthetic tooth 150 to the receiving portion 72 of the abutment.

In any case, due to the polymer construction of the receiving portion 72 of the abutment 60, the receiving portion may be altered while the dental implant is secured to the jaw in order to more adequately conform the receiving portion to the bore 152 in the tooth 150. Once the tooth 150 is secured to the receiving portion 72 of the abutment 60, the dentist may complete the appropriate procedures. For example, the dentist can complete a crown preparation. Following crown preparation, traditional impressions, temporization, crown or bridge fabrication and cementation can be completed without sacrificing the efficacy or functionality of the dental implant 20.

In addition to in vivo shaping and enhanced pathogen resistance, the present invention is also advantageous because the dental implant 20 can more accurately mimic natural tooth color. As noted, typical metal dental implant abutments are silver, gray or gold. Since the present invention uses a polymer construction, the dental implant can more easily be configured to mimic natural tooth colors without compromising the integrity of the implant.

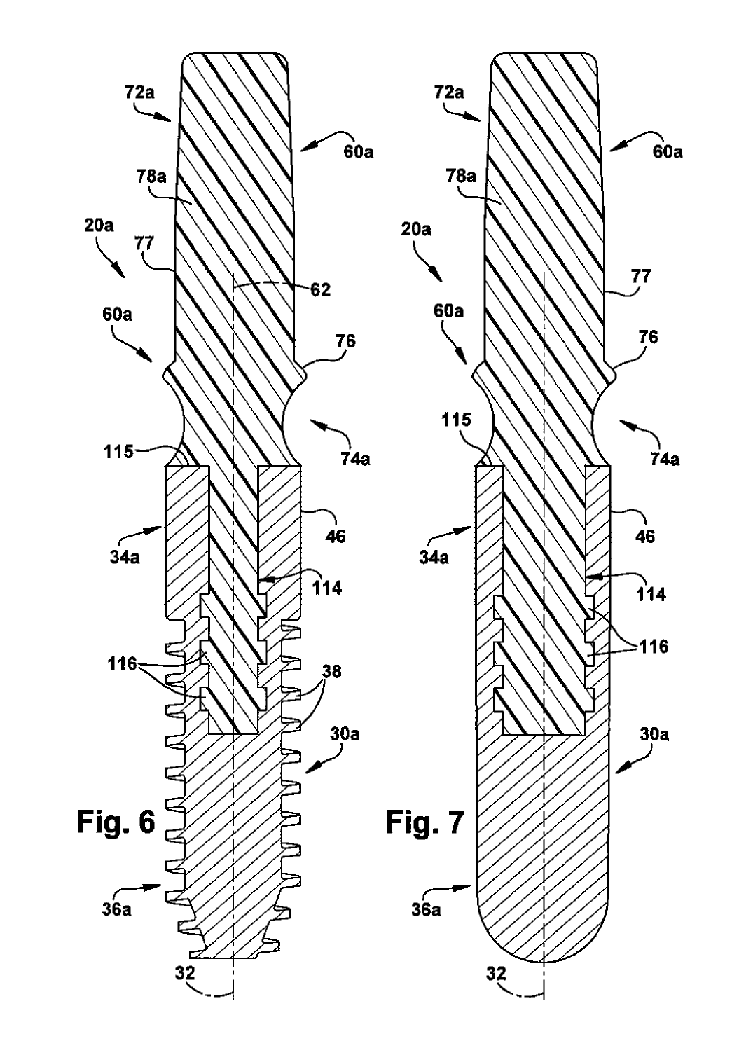

A dental implant 20a in accordance with another embodiment of the present invention is illustrated in FIGS. 6-7. The construction of the dental implant 20a in FIGS. 6-7 is similar to the construction of the dental implant 20 in FIGS. 1-5 except that the threaded fastening member 100 of the abutment 60 for securing the abutment to the implant body 30 is omitted. Instead, the attachment portion 74a of the abutment 60a is integrally formed with and fused directly to the receiving portion 34a of the implant body 30a. Accordingly, the implant body 30a, rather than the fastening member 100, constitutes the first member of the dental implant 20a in FIGS. 6-7. Structure illustrated in FIGS. 6-7 that is substantially similar to that exhibited in FIGS. 1-5 retains the same reference numeral, whereas structure in FIGS. 6-7 that is different includes the suffix “a”.

Similar to the dental implant 20 illustrated in FIGS. 1-5, the fastening portion 72a of the abutment 60a may have a press-fit or interference fit with the prosthetic tooth (not shown). Furthermore, the implant body 30a of the dental implant 20a may have various configurations for securing the dental implant within the jaw 130. The fastening portion 36a of the implant body 30a may, for example, include one or more external threads 38 or fins (FIG. 6) or may have a smooth outer surface for providing a press-fit with the jaw 130 (FIG. 7). In any case, the attachment portion 74a of the abutment 60a is formed with the receiving portion 34a of the implant body 30a such that the attachment portion of the abutment engages and overlies a proximal end surface 115 of the implant body. The attachment portion 74a engages the entire proximal end surface 115 of the implant body 30a and intersects the axis 32 of the implant body at the proximal end surface to prevent access to the proximal end surface through the attachment portion. The abutment 60a is free of openings due to the integral connection between the abutment and the implant body 30a.

The abutment 60a includes an axially extending projection 114 that extends into the implant body 30a and increases the surface area connection between the abutment and the implant body. The projection 114 may include at least one reinforcing member 116 for reinforcing the integral connection between the abutment 60a and the implant body 30a. As shown in FIGS. 6-7, the reinforcing members 116 may constitute one or more annular elements that are integrally formed with or otherwise secured to the projection 114 of the abutment 60a. The reinforcing members 116 may, for example, constitute continuous annular flanges that extend radially outward from the projection 114. Alternatively or additionally, the reinforcing members 116 may include a series of discrete, axially extending flanges or a series of threads (not shown).

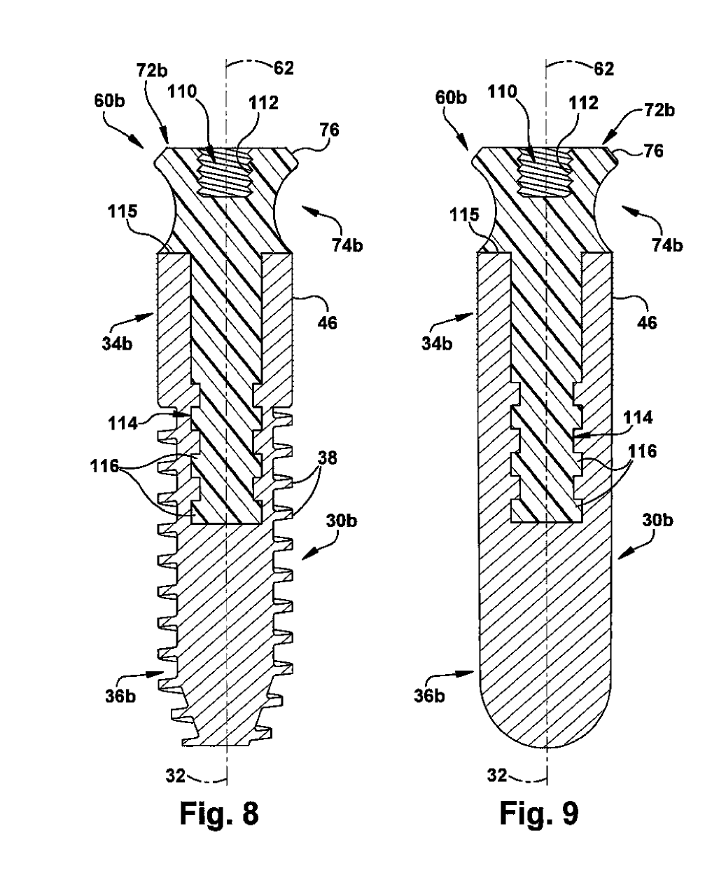

A dental implant 20b in accordance with another embodiment of the present invention is illustrated in FIGS. 8-9. The construction of the dental implant 20b in FIGS. 8-9 is similar to the construction of the dental implant 20 in FIGS. 1-5 except that the receiving portion 72b of the abutment 60b has a passage. The threaded fastening member 100 is also omitted from the dental implant 20b. Accordingly, the implant body 30b, rather than the fastening member 100, constitutes the first member of the dental implant 20b in FIGS. 8-9. Structure illustrated in FIGS. 8-9 that is substantially similar to that exhibited in FIGS. 1-5 retains the same reference numeral, whereas structure in FIGS. 8-9 that is different includes the suffix “b”. In particular, the receiving portion 72b of the abutment 60b includes a passage 110 that extends axially towards the attachment portion 74b of the abutment.

A plurality of threads 112 or other engagement structure is formed along the passage 110. The passage 110 does not, however, extend to the implant body 30b. In other words, the attachment portion 74b of the abutment 60b fully encloses the proximal end of the implant body 30b to cover and overlie the proximal end surface 115 of the implant body. The attachment portion 74b engages the entire proximal end surface 115 of the implant body 30b and intersects the axis 32 of the implant body at the proximal end surface to prevent access to the proximal end surface through the attachment portion. The receiving portion 72b of the abutment 60b is designed to accept or otherwise mate with a variety of screw-retaining attachments, such as a crown or dental prosthesis (not shown).

The implant body 30b may have various configurations for securing the dental implant 20b within the jaw 130. The fastening portion 36b of the implant body 30b may, for example, include one or more external threads 38 or fins (FIG. 8) or may have a smooth outer surface for providing a press-fit with the jaw 130 (FIG. 9).

From the above description of the invention, those skilled in the art will perceive improvements, changes and modifications. Such improvements, changes and modifications within the skill of the art are intended to be covered by the appended claims.

Having described the invention, the following is claimed:

1. A dental implant comprising:
a first member having a proximal end and a distal end and extending along a longitudinal axis, the proximal end having an axial end surface, the first member being formed from a first material; and
a second member integrally formed with the first member and adapted to receive a dental prosthesis, the second member engaging the entire proximal end surface of the first member, the second member intersecting the axis of the first member at the proximal end surface to prevent access to the proximal end surface of the first member through the second member, the second member being formed from a polymer that is different from the first material of the first member.

2. The dental implant recited in claim 1, wherein the first member is adapted to engage an implant body mounted in a jaw.

3. The dental implant recited in claim 2, wherein the first member has an axial end surface that is adapted to engage a surface of the implant body to limit axial movement of the first member relative to the implant body.

4. The dental implant recited in claim 1, wherein the first member comprises an implant body that is adapted to engage a jaw.

5. The dental implant recited in claim 1, wherein the second member includes a portion adapted to engage a tool for securing the dental implant to a jaw.

6. The dental implant recited in claim 1, wherein the second member includes a receiving portion for receiving a prosthetic tooth, the receiving portion being formed of a material that may be shaped in-vivo to conform to the prosthetic tooth.

7. The dental implant recited in claim 1 further including at least one reinforcing member that reinforces the integral connection between the first member and the second member.

8. The dental implant recited in claim 7, wherein the reinforcing member extends radially outward from the first member.

9. The dental implant recited in claim 7, wherein the at least one reinforcing member comprises a plurality of annular flanges extending from the first member.

10. The dental implant recited in claim 7, wherein the at least one reinforcing member is formed as one piece with the first member.

11. The dental implant recited in claim 7, wherein the at least one reinforcing member includes at least one axially extending recess.

12. The dental implant recited in claim 1, wherein the second member is formed from at least one of polyether ether ketone (PEEK), polymethylmethacrylate (PMMA), polyaryl ether ketone (PAEK), polyether ketone (PEK), polyether ketone ether ketone ketone (PEKEKK), polyether ketone ketone (PEKK), polyehterimide (PEI), polysulfone (PSu), and poluphenylsulfone (PPSu).

13. The dental implant recited in claim 1, wherein the first member is threaded.

14. The dental implant recited in claim 1, wherein the first member has a radially extending reinforcing member for reinforcing the integral connection between the first member and the second member.

15. A method for securing a dental implant to a jaw comprising:
providing a first member that includes a proximal end and a distal end, and a polymer second member integrally formed with the first member and adapted to receive a dental prosthesis; and
engaging the second member to rotate the first member and the second member to secure the implant with the jaw.

16. The method recited in claim 15 wherein the step of providing a first member and a second member comprises providing a first member that includes a proximal end having an axial end surface and a distal end adapted to be connected to an implant body.

17. The method recited in claim 16, wherein the second member is integrally formed with the first member such that the second member engages the entire proximal end surface of the first member and intersects an axis of the first member at the proximal end surface to prevent access to the proximal end surface through the second member.

18. The method recited in claim 15 further comprising the step of reshaping the second member in-vivo to receive a prosthetic tooth.

19. The method recited in claim 15, wherein the first member and the second member are injection molded together.

20. The method recited in claim 15 wherein the step of engaging the outer surface of the second member comprises engaging recessed portions of the outer surface of the second member.

21. The method recited in claim 15 further comprising providing the first member with at least one reinforcing member to reinforce the integral connection between the first member and the second member, the reinforcing member comprising at least one annular flange provided on the first member.
